(19) United States
(12) Patent Application Publication
(10) Pub. No.: US 2009/0171850 A1
(43) Pub. Date: Jul. 2, 2009

(54) TRANSACTION AUTHENTICATION PLATFORM USING VIDEO

(75) Inventor: Gideon A. Yuval, Mercer Island, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 11/964,225

(22) Filed: Dec. 26, 2007

(51) Int. Cl. G06Q 99/00; H04L 9/32

(52) U.S. Cl. 705/71; 705/1

(57) ABSTRACT

A transaction authentication platform using video is provided. In an illustrative implementation, a computing environment comprises a video transaction authentication engine and an instruction set comprising at least one instruction to the video transaction authentication to process, store, manage, and monitor data representative of video transaction authentication requests to generate a trust capsule representative of video authentication trust for a consumer. Consumers, merchants, and transaction processors can illustratively cooperate with the video transaction authentication engine as part of transaction fulfillment and reconciliation. Illustratively, a merchant can request generated trust capsule data for a consumer and compare the received data with the consumer at the point of sale to determine whether to fulfill a transaction. Additionally, the video data about a consumer can be captured at the point of sale and stored as part of a transaction dispute resolution process.

### BACKGROUND

One of the fundamental principles of a free market economy is that resources (e.g., products, services, money, etc.) will tend to be redistributed by voluntary transactions in a manner that maximizes wealth and/or utility to all parties involved in the transactions. For example, the price paid for a particular resource in a voluntary transaction is representative of the value of that resource to each party. Thus, monetary transactions provide a common measuring stick for comparing the relative values that different persons attach to particular resources. As such there is a natural tendency for competition between both buyers and sellers to efficiently allocate the resources and create markets that can be measured and analyzed in terms of money.

Of course different individuals will prioritize the value of resources in different ways. For example, one individual may favor higher quality while another favors lower cost, e.g., automobiles vary widely in price and quality, but ultimately, voluntary transactions between the buyer and the seller will ensure markets work efficiently from the perspectives of both supply and demand because all resources will tend to go where they are most highly valued.

Transaction authentication has become increasingly important as consumers and businesses alike engage in transactions relying on electronic communication of data. There are various transaction authentication practices that are currently deployed that rely on data encryption (both public and private key encryption), encoding, and one or more trust models. Establishing trust between a customer, merchant, and transaction processor (e.g., bank, credit card company, credit union, broker, etc.) is vital to reliable and successful transaction authentication.

Various trust modalities have been deployed to represent and execute on trust models including credit cards, debit cards, online user ids and passwords (e.g., for use in e-commerce transaction authentication), digital wallets (e.g., hardware and software solutions), and biometric transaction authentication. The commonality among trust models is the ability to confirm (with some degree of accuracy and reliability) that the consumer is authorized and allowed (i.e., having sufficient credit or funds) by the transaction processor/backer to use the trust modality (e.g., credit card, debit card) to consummate a transaction with the merchant.

In days of yore, trust was more easily established between consumers and merchants where consumers would establish “tabs” with the local merchants and the merchants would bill out to the consumers on a periodic basis to reconcile their tab. Familiarity of person is how trust is established with such practice. Stated differently, the butcher knows the Smith family and provided them with a “tab”. The butcher also knows that the Smith family has three sons, Johnny, Billy, and Frank. In the instance Mrs. Smith sends Johnny to the butcher to pick up some steak for dinner, the butcher based on the trust established by familiarity of person would provide the steaks to Johnny and put the appropriate charge on the Smith account.

The “tab” trust model is more difficult to implement in today's marketplace given the lack of familiarity between merchants and consumers, and more importantly, the inability of current practices to provide a reliable, efficient, and electronic mechanism/process to establish and authenticate such familiarity. Instead, merchants rely on other trust models to ensure that the consumer is capable of paying for the purchased product/service (e.g., cash, credit card, debit card, check, etc.). With current practices, the “tab” trust model is not easily deployed.

From the foregoing it is appreciated that there exists a need for systems and methods to ameliorate the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject matter described herein allows for systems and methods to perform transaction authentication using video. In an illustrative implementation, a computing environment comprises a video transaction authentication engine and an instruction set comprising at least one instruction to the video transaction authentication to process, store, manage, and monitor data representative of video transaction authentication requests to generate data representative of an transaction authentication or transaction authentication denial.

In an illustrative operation, a consumer provides video data representative of the consumer's person (e.g., a video of the consumer's face) to the video transaction authentication engine for storage as well as other identification data including but not limited to personal identification data and account data. The received video and other input data can be associated with the consumer to generate a profile and/or account for use in transaction authentication. In the illustrative operation a transaction processor (e.g., bank, credit card company, etc.) can cooperate with the video transaction authentication engine to provide video transaction authentication trust to the consumer to allow the consumer to participate in one or more transactions. In the illustrative operation, a merchant responsive to a request to transact (e.g., purchase a product and/or service) by a consumer, having been provided video transaction authentication trust, can request authentication of the transaction by requesting video of the consumer to the video transaction processing authentication engine as part of a request of transaction authentication.

In the illustrative operation, responsive to the request for video transaction authentication, video transaction authentication engine can process the received request and provide a trust capsule back to the merchant which can comprise various authentication data comprising video data of consumer and other associated personal and/or account data of the consumer. In the illustrative operation, the merchant can compare the received trust capsule with the consumer's presence and/or data provided by the consumer (i.e., compare the received video data of the consumer with the consumer's appearance) to allow the transaction. Further, in the illustrative operation, the merchant can capture video data of the consumer (e.g., via an illustrative electronic video capture mechanism or device) for storage.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of one example of a marketplace environment and the interaction between cooperating parties of a marketplace environment.

FIG. 2 is a block diagram of exemplary interaction between a consumer and transaction processor in a video transaction authentication environment in accordance with the herein described systems and methods.

FIG. 3 is a block diagram of exemplary interaction between a consumer and merchant in a video transaction authentication environment in accordance with the herein described systems and methods.

FIG. 4 is a block diagram of exemplary interaction between a merchant and transaction processor in a video transaction authentication environment in accordance with the herein described systems and methods.

FIG. 5 is a flow diagram of one example of a method for generating trust between a consumer and transaction processor in accordance with the herein described systems and methods.

FIG. 6 is a flow diagram of one example of a method for the authentication of a transaction using video in accordance with the herein described systems and methods.

FIG. 7 is an example computing environment in accordance with various aspects described herein.

FIG. 8 is an example networked computing environment in accordance with various aspects described herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative illustrations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

### Transaction Authentication:

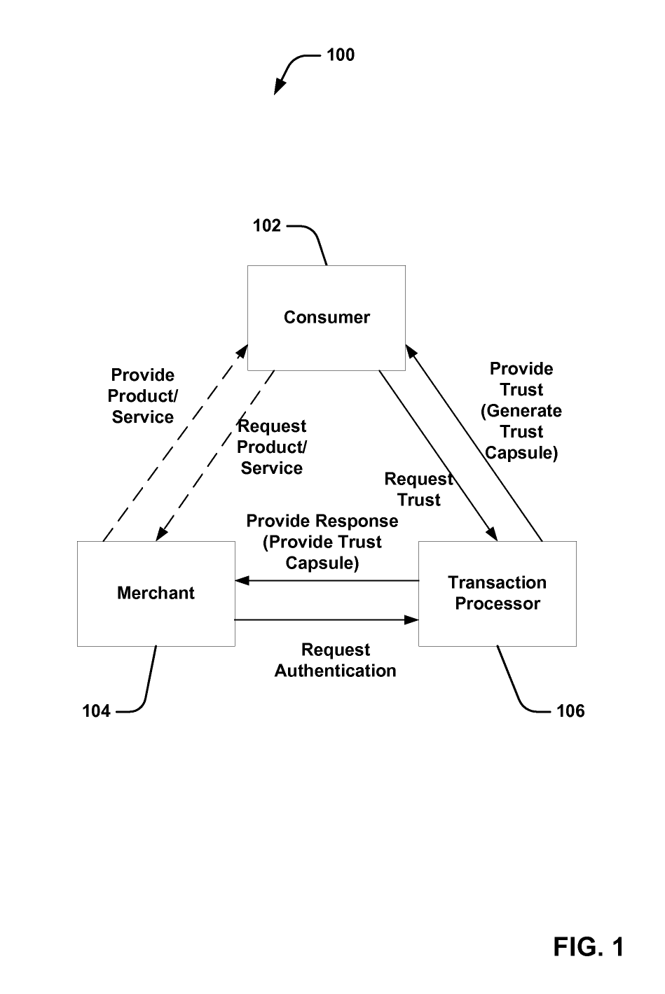

FIG. 1 describes an exemplary marketplace environment 100 where transactions can be executed. As is shown in FIG. 1, exemplary marketplace environment 100 comprises consumer 102, merchant 104, and transaction processor (e.g., credit card company, bank, VISA® Network, MasterCard® Network, American Express® Network, credit union, brokerage, etc.) 106. In an illustrative implementation, consumer 102 can cooperate with transaction processor 106 to establish transaction authentication trust. In the illustrative implementation, transaction authentication trust allows consumer 102 to cooperate with merchant 104 to participate in a transaction for a desired product/service (not shown). Additionally, illustratively, merchant 104 can cooperate with transaction processor 106 to authenticate a transaction (i.e., to test the transaction authentication trust of the consumer requesting the purchase of a product/service).

In an illustrative operation, consumer 102 can electronically interact with transaction processor 106 to request trust be established between consumer 102 and transaction processor 106. Part in parcel in the request for trust, consumer 102 can electronically provide various data (i.e., data required by transaction processor 106 to process a request for trust) including video data of the consumer, personal information data, and/or account data (e.g., in the instance consumer 102 has an account with transaction processor). Responsive to the request to establish trust, transaction processor 106 can execute on a selected trust model (e.g., commonly deployed processes surrounding whether to provide credit to a user, whether to open a bank account, whether to allow for a margin account, etc.) to determine whether transaction authentication trust (e.g., including video transaction authentication) will be provided to consumer 102 by transaction processor 106. Illustratively, if trust is to be provided by transaction processor 106 to consumer 102, a trust capsule (not shown) can be created by the transaction processor which can comprise various consumer data including but not limited to video data of consumer 102 and personal/account data for consumer 102.

In the illustrative operation and as is shown in FIG. 1, consumer 102 can also interact with the merchant 104 to request a product/service (i.e., purchase a product or service) (the dashed line is presented to indicate that the transaction might not be consummated and is dependent on transaction authentication processing). Responsive to the request for a product/service, merchant 104 can operatively electronically interact with transaction processor 106 to request transaction authentication (i.e., to verify the validity of consumer's 102 transaction authentication trust). Responsive to the request for transaction authentication by merchant 104, transaction processor can retrieve and electronically communicate a stored trust capsule (not shown) for consumer 102 to merchant 104. Using the received trust capsule data, merchant 104 can compare the received data (e.g., received video data of consumer 102) with the consumer 102 (e.g., present at the point of sale) as part of transaction authentication. Based on the transaction authentication performed by merchant 104, merchant 104 can provide the requested products/services to consumer 102 (the dashed line is presented to indicate that the transaction might not be consummated and is dependent on transaction authentication processing). In the illustrative implementation, part in parcel of the request to authenticate the transaction, merchant 104 can operatively capture video data of consumer 102 at the point of sale and electronically communicate the captured video to transaction processor 106 to consider when processing potential transaction disputes that could arise between consumer 102 and merchant 104 (e.g., in the event that consumer 102 disputes an actual purchase from merchant 104 point of sale).

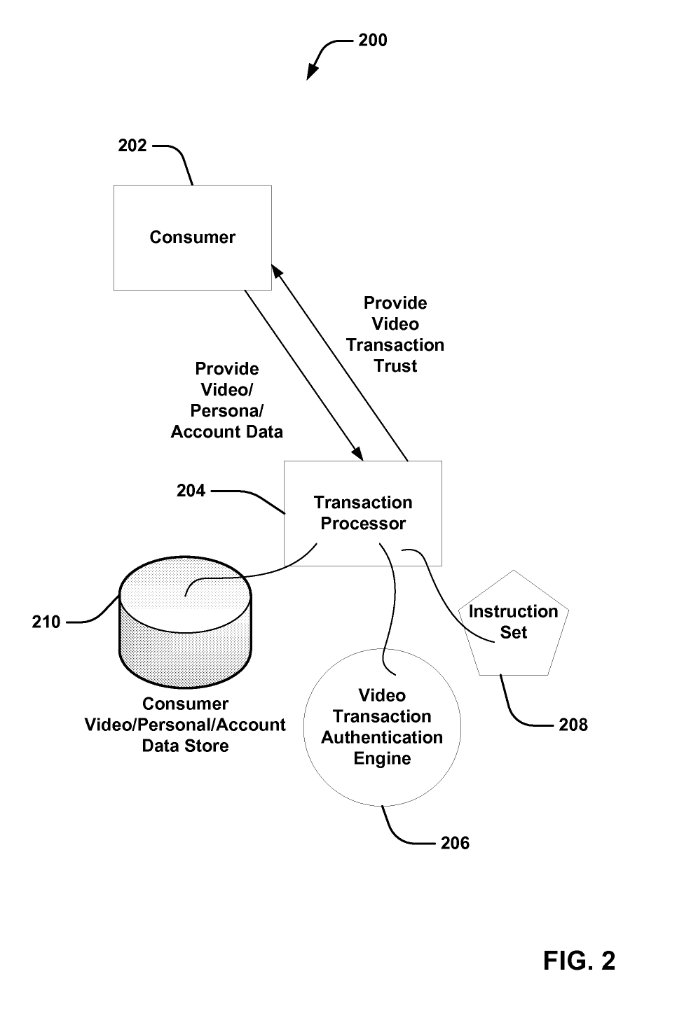

FIG. 2 describes an exemplary video transaction authentication environment 200. As is shown in FIG. 2, exemplary video transaction authentication environment 200 comprise consumer 202, transaction processor 204, video transaction authentication engine 206, instruction set 207, and consumer video/personal/account data store 210. In an illustrative implementation, consumer 202 can electronically cooperate with transaction processor 204 (e.g., over the World Wide Web or other electronic communication network) to request video transaction authentication trust be established by providing consumer video data and other consumer data. Responsive to the request to establish trust transaction processor 204 can execute video transaction authentication engine 206 which operatively cooperates with instruction set 208 having one or more instructions to instruct video transaction authentication engine to process consumer data (e.g., video, personal identification, account, or other data) to generate a trust profile (i.e., the trust profile can be created if the received consumer data satisfies one or more selected trust model parameters commonly deployed to establish trust between consumers and transaction processors—e.g., processes for establishing credit, a margin account, etc.) stored as a trust capsule (not shown). Additionally, video transaction authentication engine 206 can operatively store received consumer data (e.g., trust capsule) in consumer video/personal/account data store 210 for use in subsequent transaction authentication processing. If trust is established by transaction processor 204 (i.e., consumer has satisfied trust model conditions) for consumer 202, transaction processor 204 can electronically communicate confirmation of the established trust to consumer 202.

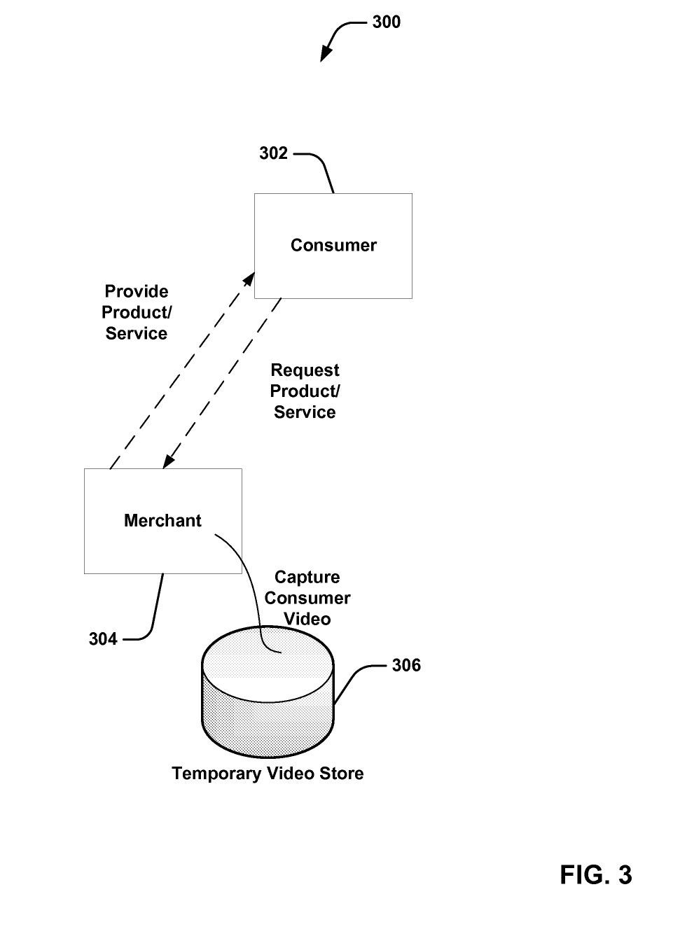

FIG. 3 schematically illustrates exemplary video transaction authentication environment 300. As is shown in FIG. 3, exemplary video transaction authentication environment 300 comprises consumer 302, merchant 304, and temporary video store 306. In an illustrative implementation, consumer 302 can interact with the merchant (e.g., at point of sale or electronically in an e-commerce context) to request the purchase of a product and/or service. Responsive to the request for the purchase of a product/service merchant can request payment for the requested product/service. Consumer 302 can offer video transaction authentication trust (not shown) (e.g., video transaction authentication trust provided by a transaction processor representative of an account balance and/or credit capable of covering the transaction price—the purchase price of the desired product/service) to merchant 304. Merchant 304 can choose to accept the video transaction authentication trust or not. If merchant 304 honors the provided trust, merchant 304 can, in an illustrative operation, can capture consumer video (e.g., any commercially available electronic video capture devices including but not limited to web-cameras, mobile phone cameras, digital cameras, etc.) for storage in temporary video store 306 and for subsequent transaction authentication/transaction dispute processing.

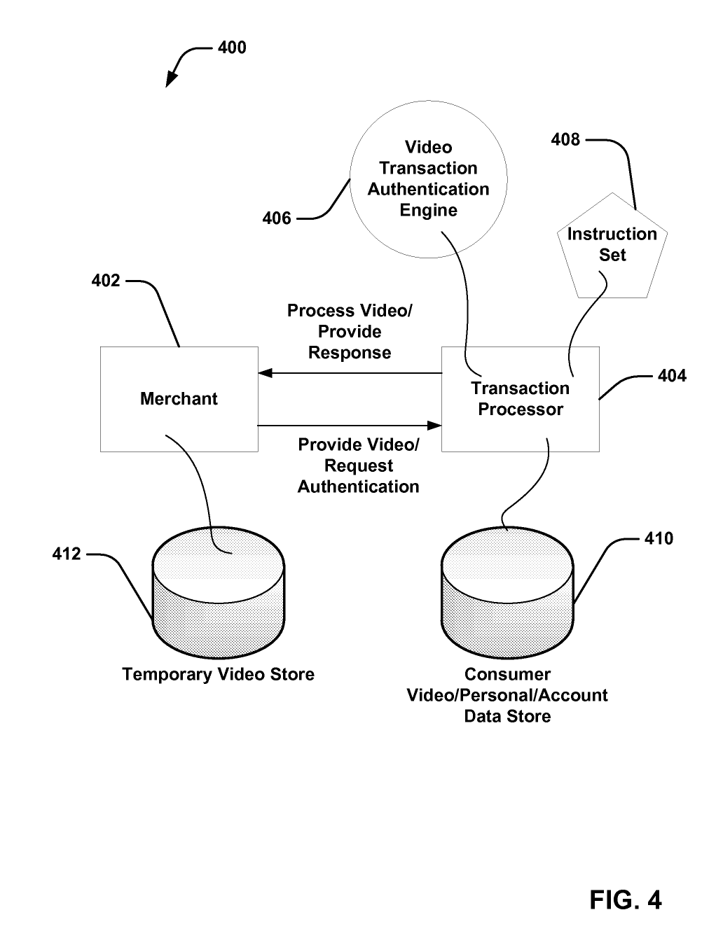

FIG. 4 schematically illustrates exemplary video transaction authentication environment 400. As is shown in FIG. 4, exemplary video transaction authentication environment 400 comprises merchant 402, temporary video store 412, transaction processor 404, video transaction authentication engine 406, and instruction set 408. In an illustrative implementation, merchant 402 can electronically interact with transaction processor 410 (e.g., according to one or more currently deployed secure communication protocols including public-key encryption) to request trust capsule data for use in transaction authentication for a transaction entered into with a consumer presenting video transaction authentication trust. In the illustrative implementation, merchant 402 can provide personal/account data about consumer (e.g., as provided by the consumer (not shown) to merchant 402) as part of the request of trust capsule data. In the illustrative implementation, responsive to a request for transaction authentication for a transaction based on video transaction authentication trust, transaction processor 404 can execute video transaction authentication engine 406 receiving at least one instruction from instruction set 408 to process video transaction authentication data using the consumer personal/account data provided by merchant 402 to retrieve and communicate the trust capsule for the consumer to merchant 402. In the illustrative implementation, consumer personal/account data can comprise telephone data, birth of date data, social security data, other personal identification data, account number data, account security question answers, or other account data.

In an illustrative operation, merchant 402 can process the trust capsule data to determine if the consumer at the point of sale is the same as presented in the trust capsule. Merchant 402 can determine whether to continue with the transaction based on this comparison. Further, in the illustrative operation, merchant 402 can capture video data for the consumer (e.g., with the consumer's consent) at the point of sale (e.g., using an electronic video data capture device/mechanism) for storage in temporary video data store 412. The stored captured video data can be used by merchant 402 and transaction processor 404 as part of a selected one or more transaction dispute process. In the illustrative implementation, the captured video of the consumer can comprise data representative of the consumer saying “It's a deal” (or some other confirmatory language). In the illustrative implementation, the captured video can be stored in temporary video data store 412 until the deadline (i.e., that can be imposed by transaction processor 404) has passed.

In an illustrative implementation, a video feed from the transaction processor 404 can be provided to a security officer (not shown) (local or geographically disparate from the consumer) according to a selected frequency (i.e., randomly to be able to identify impersonators and provide deterrence to would-be impersonators) as part of transaction authentication as it may be inconvenient (or socially unacceptable) for the merchant 402 to study the authenticated video while the consumer (not shown) is present. Further, in the illustrative implementation, merchant 402 can operatively look at one or more still pictures from the authenticated video so as to have more lead time to prevent a fraudulent transaction.

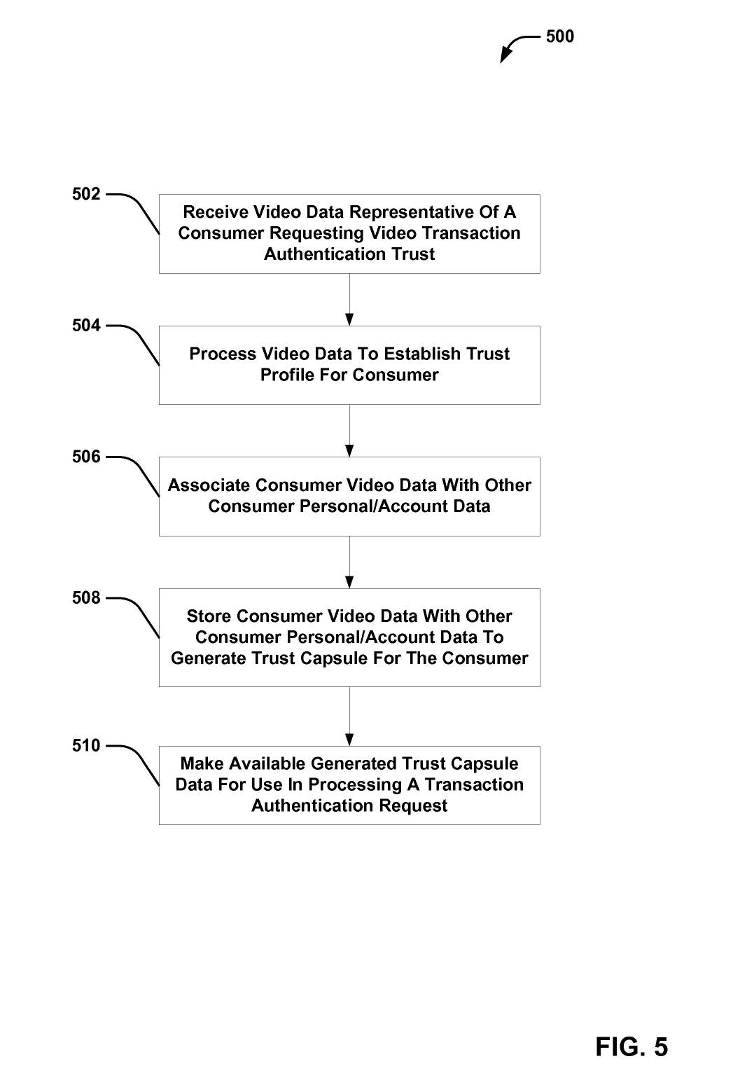

FIG. 5 is a flow diagram of one example of a method 500 for establishing video transaction authentication trust for a consumer. Processing begins at block 502 where video data representative of a consumer requesting video transaction authentication trust is received. Processing proceeds to block 504 where the received consumer video data is processed to establish a trust profile for the consumer. Processing proceeds to block 506 where the received consumer video data is associated with other consumer personal/account data. From there, processing proceeds to block 508 where consumer video data is stored with other consumer personal/account data to generate a trust capsule for the consumer. Processing then proceeds to block 510 where the generated trust capsule data is made available for use in transaction authentication processing (e.g., by a video transaction authentication engine).

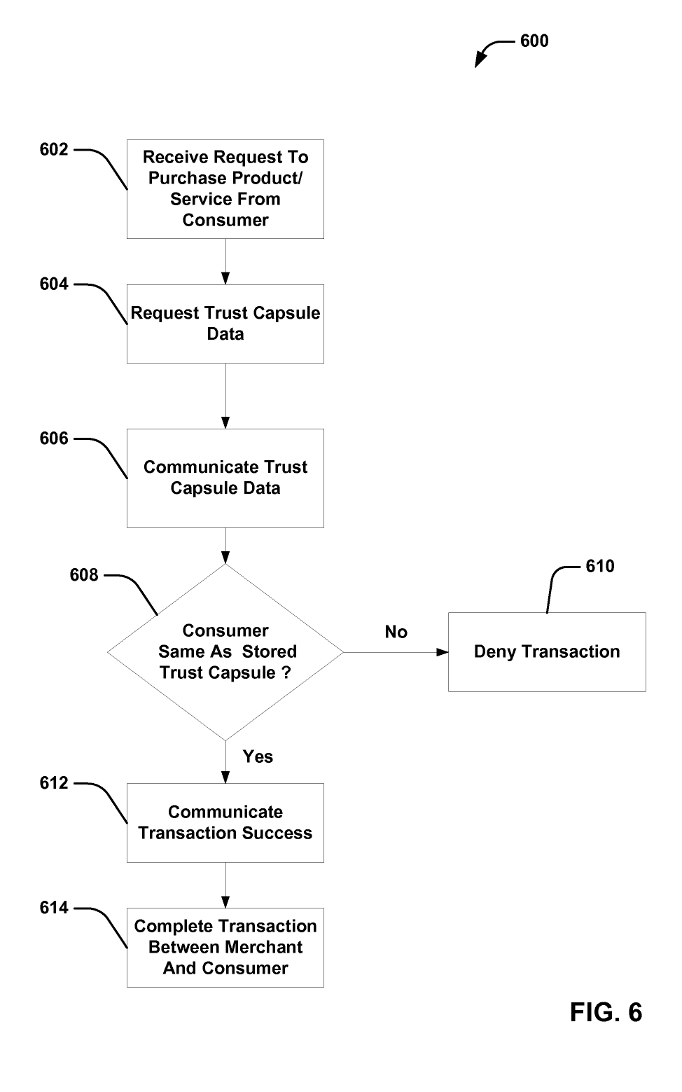

FIG. 6 is a flow diagram of one example of a method 600 for video transaction authentication. Processing begins at block 602 where a request is received by an exemplary merchant to purchase a product/service from a consumer. Processing then proceeds to block 604 where a request for trust capsule data (i.e., trust capsule data for a consumer) is provided by a cooperating merchant to a cooperating transaction processor. Illustratively, included in the request for trust capsule data can be various personal/account for a consumer for whom trust capsule data is being requested. Responsive to a request for trust capsule data using the one or more communicated consumer personal/account data, the desired trust capsule data is retrieved and communicated to the requesting party at block 606. A check is then performed at block 608 by the merchant to determine if the person shown in the communicated trust capsule data is the same person as that of the consumer (i.e., a cooperating merchant compares received video authorization data about a consumer with the consumer who is at the merchant's place of business). If the check at block 608 indicates that the consumer at the point of sale is not the same as described by the trust capsule data, processing proceeds to block 610 where the transaction is denied by the merchant.

However, if the check at block 608 indicates that the consumer at the point of sale is the same as described by the received trust capsule data for the consumer as determined by the cooperating merchant, processing proceeds to block 612 where the transaction is authenticated. Processing then proceeds to block 614 where the transaction between the merchant and the consumer is completed.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

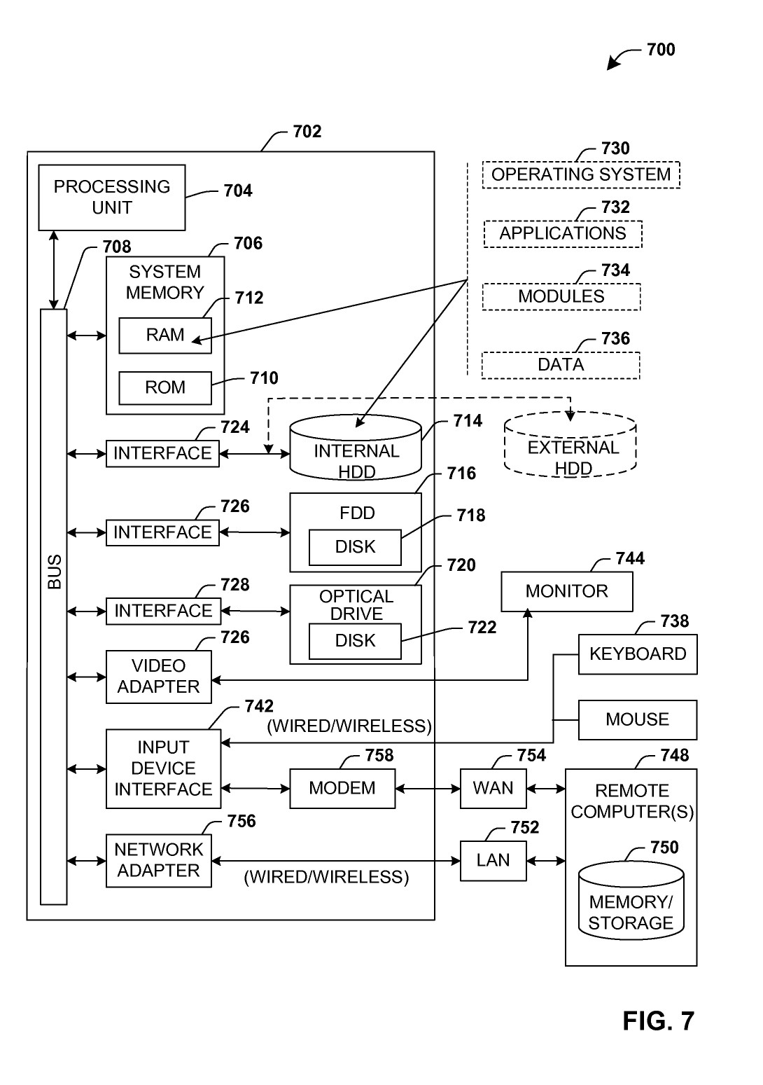

FIG. 7 illustrates a block diagram of a computer operable to execute the disclosed architecture. In order to provide additional context for various aspects of the subject specification, FIG. 7 and the following discussion are intended to provide a brief, general description of a suitable computing environment 700 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

More particularly, and referring to FIG. 7, an example environment 700 for implementing various aspects as described in the specification includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the specification can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are example and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

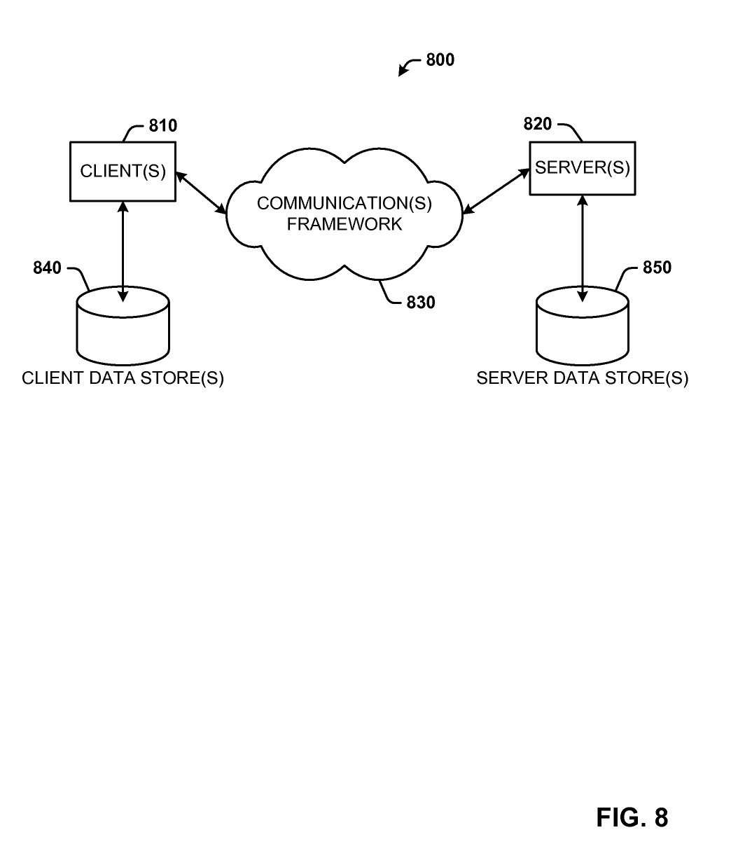

Referring now to FIG. 8, there is illustrated a schematic block diagram of an exemplary computing environment 800 in accordance with the subject invention. The system 800 includes one or more client(s) 810. The client(s) 810 can be hardware and/or software (e.g., threads, processes, computing devices). The client(s) 810 can house cookie(s) and/or associated contextual information by employing the subject invention, for example. The system 800 also includes one or more server(s) 820. The server(s) 820 can also be hardware and/or software (e.g., threads, processes, computing devices). The servers 820 can house threads to perform transformations by employing the subject methods and/or systems for example. One possible communication between a client 810 and a server 820 can be in the form of a data packet adapted to be transmitted between two or more computer processes. The data packet may include a cookie and/or associated contextual information, for example. The system 800 includes a communication framework 830 (e.g., a global communication network such as the Internet) that can be employed to facilitate communications between the client(s) 810 and the server(s) 820.

Communications can be facilitated via a wired (including optical fiber) and/or wireless technology. The client(s) 810 are operatively connected to one or more client data store(s) 840 that can be employed to store information local to the client(s) 810 (e.g., cookie(s) and/or associated contextual information). Similarly, the server(s) 820 are operatively connected to one or more server data store(s) 850 that can be employed to store information local to the servers 820.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system to facilitate transaction authentication using video, comprising:
a video transaction authentication engine operable to process video data;
an instruction set comprising at least one instruction to instruct the video transaction authentication engine to process video data to generate and store a trust capsule for a first cooperating party,
wherein the video transaction authentication engine provides the stored trust capsule data to a second cooperating party as part of transaction authentication being performed by the second cooperating party comprising,
comparing received trust capsule data by the second cooperating party with features of the first cooperating party observed by the second cooperating party.

2. The system as recited in claim 1, further comprising a data store cooperative with the video transaction operative to store data comprising video data, transaction data, merchant data, transaction processor data, and consumer data.

3. The system as recited in claim 1, further comprising a communication network operative to communicate data comprising video data, transaction data, merchant data, transaction processor data, and consumer data.

4. The system as recited in claim 1, further comprising a digital video capture device for use in capturing digital video data.

5. The system as recited in claim 1, wherein the video transaction authentication engine comprises a computing application operative on a computing environment.

6. The system as recited in claim 3, wherein the video transaction authentication engine is accessible by one or more cooperating parties comprising merchant, consumer, and transaction processor.

7. The system as recited in claim 6, wherein a merchant cooperates with a transaction processor using a secure communication protocol.

8. The system as recited in claim 7, wherein the secure communication protocol comprises public-key encryption.

9. The system as recited in claim 6, wherein a consumer electronically communicates video data with a transaction processor to establish video transaction authentication trust.

10. The system as recited in claim 9, wherein the transaction processor employs one or more selected trust models to establish the video transaction authentication trust comprising trust model for establishing credit.

11. A method for facilitating transaction authentication using video comprising:
receiving electronic video data of a consumer;
processing the electronic video data of the consumer to generate a trust capsule for the consumer;
storing the generated trust capsule of the consumer;
requesting, by a merchant, trust capsule data for the consumer;
providing the stored trust capsule to the merchant; and
comparing by the merchant received trust capsule data of the consumer with one or more features of the consumer as observed by the merchant as part of transaction authentication.

12. The method as recited in claim 11, further comprising electronically providing by the merchant other consumer data comprising personal identification data and account data as part of the request for the stored trust capsule.

13. The method as recited in claim 11, further comprising associating other personal identification data and account data for the consumer to generate the trust capsule for the consumer.

14. The method as recited in claim 13, further comprising processing the other received consumer data with the received electronic video data for the consumer to generate the trust capsule for the consumer.

15. The method as recited in claim 14, further comprising presenting a video transaction authentication trust to a merchant by the consumer, the video transaction authentication trust representative of the consumer trust capsule.

16. The method as recited in claim 15, further comprising electronically communicating a request for transaction authentication having personal/account data for the consumer captured at the point-of-sale/time-of-sale using public key encryption.

17. The method as recited in claim 16, further comprising, comparing the personal/account data for the consumer with data of the stored generated trust capsule.

18. The method as recited in claim 17, further comprising generating transaction authentication representative of a positive transaction authentication based on a positive comparison of the video data from the received request for video transaction authentication of the generated trust capsule with observed features of the consumer.

19. The method as recited in claim 17, further comprising generating transaction authentication representative of a negative transaction authentication based on a negative comparison between the video data from the received request for video transaction authentication of the generated trust capsule with observed features of the consumer.

20. In a computing environment, a method to perform transaction authentication comprising:
receiving electronic video data of a consumer;
processing the electronic video data of the consumer to establish a trust capsule for the consumer;
storing the generated trust capsule for the consumer;
responsive to a request for video transaction authentication for the consumer, the request having point-of-sale/time-of-sale captured video data of the consumer, comparing the video data from the received request for video transaction authentication with the stored trust profile of the consumer; and
providing data representative of the authentication of the transaction based on the results of the comparison of the video data from the received request for video transaction authentication with the stored trust profile of the consumer.
